(19) United States
(12) Patent Application Publication
(10) Pub. No.: US 2025/0011618 A1
(43) Pub. Date: Jan. 9, 2025

(54) UNSATURATED POLYESTER COMPOSITIONS FOR METAL PACKAGING COATINGS

(71) Applicant: Eastman Chemical Company, Kingsport, TN (US)

(72) Inventors: Katelyn Rose Houston, Johnson City, TN (US); Samuel Jean Puaud, Lille (FR); Hongkun He, Kingsport, TN (US); Goliath Beniah, Johnson City, TN (US); Cameron Lee Brown, Kingsport, TN (US)

(73) Assignee: Eastman Chemical Company, Kingsport, TN (US)

(21) Appl. No.: 18/577,766

(22) PCT Filed: Jul. 13, 2022
(86) PCT No.: PCT/US2022/036902

§ 371 Date: Jan. 9, 2024

Related U.S. Application Data
(60) Provisional application No. 63/203,252, filed on Jul. 14, 2021.

(51) Int. Cl. C09D 167/06

(52) U.S. Cl. CPC C09D 167/06

(57) ABSTRACT

This invention relates to unsaturated polyester compositions comprising cycloaliphatic diols such as 2,2,4,4-tetramethyl-1,3-cyclobutanediol (TMCD) that are curable with an isocyanate crosslinker, an amino crosslinker, or a combination thereof. The unsaturated polyester compositions provide a good balance of desirable coating properties such as solvent resistance and wedge bend resistance in metal packaging applications.

### FIELD OF THE INVENTION

This invention relates to unsaturated polyester compositions that are curable with an isocyanate crosslinker, an amino crosslinker, or a combination thereof. More particularly, this invention relates to unsaturated polyester compositions comprising a cycloaliphatic diol such as 2,2,4,4-tetramethyl-1,3-cyclobutanediol (TMCD). Coating compositions prepared from such unsaturated polyesters are capable of providing a good balance of desirable coating properties such as solvent resistance and wedge bend resistance for metal packaging applications.

### BACKGROUND OF THE INVENTION

Metal containers are commonly used for food and beverage packaging. The containers are typically made of steel or aluminum. A prolonged contact between the metal and the filled product can lead to corrosion of the container. To prevent direct contact between filled product and metal, a coating is typically applied to the interior of the food and beverage cans. In order to be effective, such a coating must have certain properties that are needed for protecting the packaged products and the integrity of the metal container, such as adhesion, corrosion resistance, chemical resistance, flexibility, stain resistance, and hydrolytic stability. Moreover, the coating must be able to withstand processing conditions during can fabrication and food sterilization. Coatings based on a combination of epoxy and phenolic resins are known to be able to provide a good balance of the required properties and are most widely used. Some industry sectors are moving away from food contact polymers made with bisphenol A (BPA), a basic building block of epoxy resins. Thus, there exists a need for non-BPA containing coatings for use in interior can coatings.

Polyester resins are of particular interest to the coating industry to be used as a replacements for epoxy resins because of their comparable properties such as flexibility and adhesion. Polyesters used for metal packaging typically have a hydroxyl number lower than 30 mgKOH/g in order to provide the high molecular weights required for achieving the desirable coating properties such as, for example, the impact resistance needed for can fabrication. As is known by one skilled in the art, a polyester having a hydroxyl number greater than 50 or even greater than 100 mgKOH/g is typically required for formulating with an isocyanate or amino crosslinker to achieve sufficient crosslinking in order to provide the desirable coating properties.

Thus, there remains a need for a curable coating composition for metal packaging that is capable of providing enhanced crosslinking between polyesters having low hydroxyl numbers and crosslinkers such as isocyanate and amino crosslinkers in order to achieve the desirable coating properties such as solvent resistance and wedge bend resistance.

### SUMMARY OF THE INVENTION

There is now provided unsaturated polyester compositions comprising cycloaliphatic diols such as 2,2,4,4-tetramethyl-1,3-cyclobutanediol (TMCD), that are curable with an isocyanate crosslinker, an amino crosslinker, or a combination thereof. The unsaturated polyester compositions provide a good balance of desirable coating properties such as solvent resistance and wedge bend resistance in metal packaging applications.

In one embodiment, the invention is a thermosetting coating composition comprising:
a. a curable unsaturated polyester, which is the reaction product of the monomers comprising:
   i. a cycloaliphatic diol in an amount of 57 to 100 mole %, based on the total moles of i-iii,
   ii. an acyclic diol in an amount of 0 to 35 mole %, based on the total moles of i-iii,
   iii. a polyol having 3 or more hydroxyl groups in an amount of 0 to 8 mole %, based on the total moles of i-iii,
   iv. an α,β-unsaturated dicarboxylic acid or anhydride in an amount of 3 to 20 mole %, based on the total moles of iv-vi,
   v. an aromatic diacid in an amount of 55 to 97 mole %, based on the total moles of iv-vi, and
   vi. a saturated aliphatic diacid in an amount of 0 to 25 mole %, and
b. one or more crosslinkers selected from isocyanate crosslinker and amino crosslinker,
   wherein said unsaturated polyester has a hydroxyl number of 8 to 30 mgKOH/g, an acid number of 0 to 10 mgKOH/g, a glass transition temperature (Tg) of 35 to 110° C., number average molecular weight of 4,000 to 25,000 g/mole, and weight average molecular weight of 13,000 to 200,000 g/mole.

### DETAILED DESCRIPTION

### Definitions

In this specification and in the claims that follow, reference will be made to a number of terms, which shall be defined to have the following meanings.

“Alkyl” means an aliphatic hydrocarbon. The alkyl can specify the number of carbon atoms, for example (C₁₋₅)alkyl. Unless otherwise specified, the alkyl group can be unbranched or branched. In one embodiment, the alkyl group is branched. In one embodiment, the alkyl group is unbranched. Non-limiting examples of alkanes include methane, ethane, propane, isopropyl (i.e., branched propyl), butyl, and the like.

“Alcohol” means a chemical containing one or more hydroxyl groups.

“Aldehyde” means a chemical containing one or more —C(O)H groups.

Values may be expressed as “about” or “approximately” a given number. Similarly, ranges may be expressed herein as from “about” one particular value and/or to “about” or another particular value. When such a range is expressed, another aspect includes from the one particular value and/or to the other particular value. Similarly, when values are expressed as approximations, by use of the antecedent “about,” it will be understood that the particular value forms another aspect.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “includes,” and “include” have the same open-ended meaning as “comprising,” “comprises,” and “comprise” provided above.

“Chosen from” as used herein can be used with “or” or “and.” For example, Y is chosen from A, B, and C means Y can be individually A, B, or C. Alternatively, Y is chosen from A, B, or C means Y can be individually A, B, or C, or a combination of A and B, A and C, B and C, or A, B, and C.

Disclosed herein is an unexpected discovery that coating compositions based on certain unsaturated polyesters having cycloaliphatic diols in the compositions are capable of providing good solvent resistance and bending ability for metal packaging applications.

In one embodiment of the invention, there is provided a thermosetting coating composition for use in metal packaging comprising:
a. a curable unsaturated polyester, which is the reaction product of the monomers comprising:
   i. a cycloaliphatic diol in an amount of 57 to 100 mole %, based on the total moles of i-iii,
   ii. an acyclic diol in an amount of 0 to 35 mole %, based on the total moles of i-iii,
   iii. a polyol having 3 or more hydroxyl groups in an amount of 0 to 8 mole %, based on the total moles of i-iii,
   iv. an α,β-unsaturated dicarboxylic acid or anhydride in an amount of 3 to 20 mole %, based on the total moles of iv-vi,
   v. an aromatic diacid in an amount of 55 to 97 mole %, based on the total moles of iv-vi, and
   vi. a saturated aliphatic diacid in an amount of 0 to 25 mole %, and
b. one or more crosslinkers selected from isocyanate crosslinker and amino crosslinker,
wherein said unsaturated polyester has a hydroxyl number of 8 to 30 mgKOH/g, an acid number of 0 to 10 mgKOH/g, a glass transition temperature (Tg) of 35 to 110° C., number average molecular weight of 4,000 to 25,000 g/mole, and weight average molecular weight of 13,000 to 200,000 g/mole.

In some embodiments of the invention, the thermosetting coating composition has a solvent resistance as measured by the method of ASTM D7835 of greater than 20 MEK double rubs, or greater than 30 MEK double rubs, or greater than 40 MEK double rubs, or greater than 50 MEK double rubs, or greater than 60 MEK double rubs, or greater than 70 MEK double rubs or greater than 100 MEK double rubs, or 20-100, 30-100, 40-100, 50-100, 60-100, 70-100, 80-100, 90-100, 50-150, 60-150, 70-150, 80-150, 90-150, 50-200, 60-200, 70-200, 80-200, or 90-200 MEK double rubs.

In other embodiments of the invention, the thermosetting coating composition has a wedge bend resistance of 60-100, 70-100, 80-100, 85-100, or 90-100 as measured by the method of ASTM D3281.

In further embodiments, the thermosetting coating composition of this invention has a solvent resistance of greater than 40 MEK double rubs as measured by ASTM D7835 and a wedge bend resistance (% pass) of 60-100 as measured by ASTM D3281.

In some embodiments of the invention, said cycloaliphatic diol (i) is in an amount of 65 to 95 mole %, said acyclic diol (ii) in an amount of 5 to 30 mole %, said polyol (iii) in an amount of 0 to 5 mole %, said α,β-unsaturated diacid or anhydride (iv) in an amount of 4 to 15 mole %, said aromatic diacid (v) in an amount of 65 to 96 mole %, and said aliphatic diacid (vi) in an amount of 0 to 20 mole %.

In further embodiments, said cycloaliphatic diol (i) is in an amount of 72 to 89 mole %, said acyclic diol (ii) in an amount of 10 to 25 mole %, said polyol (iii) in an amount of 1 to 3 mole %, said α,β-unsaturated diacid or anhydride (iv) in an amount of 4 to 8 mole %, said aromatic diacid (v) in an amount of 74 to 96 mole %, and said aliphatic diacid (vi) in an amount of 0 to 18 mole %.

In other aspects, said cycloaliphatic diol is in an amount of 30-60, 32-58, 35-55, 37-53, 40-50, or 42-48 mole %, based on the total moles of i-iii.

In further aspects, said acyclic diol is in an amount of 0-35, 2-32, 5-30, 7-28, or 10-25 mole %, based on the total moles of i-iii.

In other aspects, said polyol having 3 or more hydroxyl groups in an amount of 0-8, 0-7, 0-6, 0-5, 0-4, 0-3, 1-7, 1-5, 1-3, 2-7, 2-5, or 2-3 mole %, based on the total moles of i-iii.

In other aspects, said α,β-unsaturated diacid or anhydride is in an amount of 3-20, 4-17, 4-15, 4-13, 4-10, 4-8, 5-15, 5-10, 5-8, 6-10, or 6-8 mole %, based on the total moles of iv-vi.

In other aspects, said aromatic diacid in in an amount of 55-97, 60-95, 65-90, 70-85, 75-80, 65-96, 70-90, 72-85, 74-96, 70-93, 75-90, or 80-85 mole %, based on the total moles of iv-vi,

In other aspects, said aliphatic diacid is in an amount of 0-25, 0-20, 0-18, 0-15, 0-10, 0-5, 5-25, 5-20, 5-15, 5-10, 10-25, 10-20, 10-15, 15-25, 15-20, or 20-25 mole %, based on the total moles of iv-vi.

Examples of said cycloaliphatic diol (i) include 2,2,4,4-tetramethyl-1,3-cyclobutanediol (TMCD), 1,4-cyclohexanedimethanol, 1,3-cyclohexanedimethanol, 1,2-cyclohexanedimethanol, tricyclodecanedimethanol (TCDDM), isosorbide, and dinorbornanedimethanol (DNDM). Desirably, the cycloaliphatic diol is 2,2,4,4-tetramethyl-1,3-cyclobutanediol (TMCD), 1,4-cyclohexanedimethanol, or a mixture thereof.

Examples of said acyclic diol (ii) include 1,6-hexanediol, 1,4-butanediol, 2-methyl-1,3-propanediol, neopentyl glycol, hydroxypivalyl hydroxypivalate, 2-butyl-2-ethyl-1,3-propanediol, and mixtures thereof. In some embodiments, said diol (ii) is selected from 1,6-hexanediol, 1,4-butanediol, 2-methyl-1,3-propanediol, neopentyl glycol, and mixtures thereof.

Examples of said polyol include 1,1,1-trimethylolpropane, 1,1,1-trimethylolethane, glycerol, pentaerythritol, and mixtures thereof. Desirably, the triol is 1,1,1-trimethylolpropane.

Examples of α,β-unsaturated diacid or anhydride (iv) include maleic acid or its anhydride, crotonic acid or its anhydride, itaconic acid or its anhydride, citraconic acid or its anhydride, mesaconic acid, phenylmaleic acid or its anhydride, t-butyl maleic acid or its anhydride, and mixtures thereof. Desirably, said α,β-unsaturated diacid or anhydride (iv) is one or more selected from the group consisting of maleic anhydride, maleic acid, fumaric acid, itaconic anhydride, and itaconic acid. It should be noted that the aforementioned diacids include their monoesters and diesters such as, for example, dimethyl maleate and dimethyl fumarate.

Examples of said aromatic diacid (v) include isophthalic acid and its esters, such as dimethyl isophthalate, and terephthalic acid and its esters such as dimethyl terephthalate.

Said aliphatic diacid (vi) includes C₄-C₁₂ diacids and their esters, such as succinic acid, adipic acid, sebacic acid, dodecanedioic acid, 1,4-cyclohexane dicarboxylic acid, 1,3-cyclohexane dicarboxylic acid, 1,2-cyclohexane dicarboxylic acid, and their methyl esters; and (hydrogenated) dimer acid (C₃₆). Desirably, when longer chain diacids (>C₁₀) are used, they are at a smaller ratio such as 1-5, 1-4, 1-3, or 1-2 mole %. In some embodiments, said aliphatic diacid is one or more selected from succinic acid, adipic acid, sebacic acid, 1,4-cyclohexane dicarboxylic acid, and 1,3-cyclohexane dicarboxylic acid. Desirably, said aliphatic diacid is sebacic acid, adipic acid, or a mixture thereof.

Said unsaturated polyester has a glass transition temperature (Tg) of 35-110° C., 40-110° C., 40-100° C., 40-90° C., 40-80° C., 45-100° C., 50-100° C., 55-100° C., 60-100° C., 65-100° C., 45-90° C., 50-90° C., 55-90° C., 60-90° C., 65-90° C., 45-85° C., 50-85° C., 55-85° C., 60-85° C., 65-85° C., 45-80° C., 50-80° C., 55-80° C., or 60-80° C.

Said unsaturated polyester is synthesized the presence of a catalyst. Examples of catalysts that can be used are based on titanium, tin, gallium, zinc, antimony, cobalt, manganese, germanium, alkali metals, particularly lithium and sodium, alkaline earth compounds, aluminum compounds, combinations of aluminum compounds with lithium hydroxide or sodium hydroxide. In one class of this embodiment, the catalyst is based on titanium or tin.

In one class of this embodiment, the catalyst is present from 1 to 500 ppm. In one subclass of this class, the catalyst is a tin catalyst. In one subclass of this class, the catalyst is a titanium catalyst.

In one class of this embodiment, the catalyst is present from 1 to 300 ppm. In one subclass of this class, the catalyst is a tin catalyst. In one subclass of this class, the catalyst is a titanium catalyst.

In one class of this embodiment, the catalyst is present from 5 to 125 ppm. In one subclass of this class, the catalyst is chosen from a tin catalyst or a titanium catalyst. In one subclass of this class, the catalyst is a tin catalyst. In one subclass of this class, the catalyst is a titanium catalyst.

In one class of this embodiment, the catalyst is present from 10 to 100 ppm. In one subclass of this class, the catalyst is chosen from a tin catalyst or a titanium catalyst. In one subclass of this class, the catalyst is a tin catalyst. In one subclass of this class, the catalyst is a titanium catalyst.

Examples of suitable titanium compounds include titanium(IV) 2-ethylhexyloxide (e.g., Tyzor® TOT available commercially from Dorf Ketal), titanium(IV) (triethanolaminato)isopropoxide (e.g., Tyzor® TE available commercially from Dorf Ketal), tetraisopropyl titanate, titanium diisopropoxide bis(acetylacetonate), and tetrabutyl titanate (e.g., Tyzor® TBT available commercially from Dorf Ketal). Examples of suitable tin compounds include butyltin tris-2-ethylhexanoate, butylstannoic acid, stannous oxalate, dibutyltin oxide.

Said unsaturated polyester has an acid number of 0-10, 0-8, 0-5, 0-3, 0-2, 0-1, 1-5, 1-4, 1-3, 2-8, 2-6, 3-8, 3-6, 4-10, 4-8, 4-6, 5-10, or 5-8 mgKOH/g.

Said unsaturated polyester has a hydroxyl number of 8-30, 10-28, 11-26, 8-25, 10-25, 12-25, 14-25, 8-23, 10-23, 12-23, 14-23, 10-20, 12-20, 14-20, 16-20, 10-18, 12-18, 14-18, 10-16, or 12-16 mgKOH/g.

Said unsaturated polyester has a number average weight of 4,000-25,000, 4,000-20,000, 4,000-15,000, 5,000-14,000, 5,000-13,000, 6,000-14,000, 6,000-13,000, 7,000-14,000, or 7,000-13,000 g/mole; weight average weight of 13,000-200,000, 14,000-100,000, 15,000-60,000, 13,000-150,000, 13,000-100,000, 13,000-80,000, 13,000-60,000, 14,000-150,000, 14,000-100,000, 14,000-80,000, 14,000-60,000, 15,000-150,000, 15,000-100,000, or 15,000-80,000 g/mole.

Said unsaturated polyester has an inherent viscosity of 0.05-0.8, 0.1-0.7, 0.2-0.7, 0.3-0.7, 0.4-0.7, 0.5-0.7, 0.6-0.7, 0.1-0.6, 0.2-0.6, 0.3-0.6, 0.4-0.6, 0.5-0.6, 0.1-0.5, 0.2-0.5, 0.3-0.5, 0.4-0.5, 0.1-0.4, 0.2-0.4, 0.3-0.4, 0.1-0.3, or 0.2-0.3 dL/g (determined at 25° C., using 0.5 weight % solution in 60/40 phenol/1,1,2,2-tetrachloroethane).

In another embodiment, the coating composition of the present invention comprises said unsaturated polyester (a) in an amount of 70-90 weight % and said crosslinker (b) in an amount of 10-30 weight %, based on the total weight of (a) and (b). In some embodiments, the unsaturated polyester (a) is in 70-90, 70-85, 70-80, 75-90, 75-85, 75-80, 80-90, or 80-85 weight %; and the isocyanate crosslinker (b) in 10-30, 15-30, 20-30, 10-25, 15-25, 20-25, 10-20, or 15-20 weight %, based on the total weight of (a) and (b).

The unsaturated polyester used in this invention is designed to have a hydroxyl number in the range of 8 to 30 mgKOH/g in order to obtain the desirable coating properties for use in metal packaging. As is known by one skilled in the art, a polyester having a hydroxyl number greater than 50 or even greater than 100 mgKOH/g is typically required for formulating with an isocyanate or amino crosslinker to achieve sufficient crosslinking in order to provide desirable solvent resistance of a coating. In this invention, however, coatings exhibiting satisfactory solvent resistance can be achieved by using unsaturated polyesters having hydroxyl numbers lower than 30 mgKOH/g.

In one embodiment, said crosslinker (b) is an isocyanate crosslinker. The isocyanate crosslinker suitable for this invention may be blocked or unblocked isocyanate type. Examples of suitable isocyanate crosslinkers include, but are not limited to, 1,6-hexamethylene diisocyanate, methylene bis(4-cyclohexyl isocyanate), and isophorone diisocyanate. Desirably, the isocyanate crosslinker is isophorone diisocyanate (IPDI) or blocked IPDI available from COVESTRO as Desmodur® BL 2078/2.

In another embodiment, said crosslinker (b) is an amino crosslinker. The amino resin crosslinker can be a melamine-formaldehyde type or benzoguanamine-formaldehyde type cross-linking agent, i.e., a cross-linking agent having a plurality of —N(CH₂OR³)₂ functional groups, wherein R³ is C1-C4 alkyl, preferably methyl or butyl.

In general, the amino cross-linking agent may be selected from compounds of the following formulae, wherein R³ is independently C₁-C₄ alkyl:

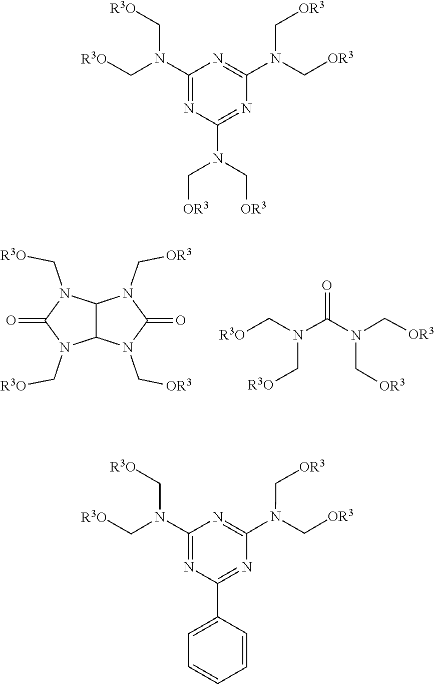

The amino cross-linking agents suitable for this invention are hexamethoxymethylmelamine, hexabutoxymethylmelamine, tetramethoxymethylbenzoguanamine, tetrabutoxymethylbenzoguanamine, tetramethoxymethylurea, mixed butoxy/methoxy substituted melamines, and the like. Further, amino resins having free amino (—NH₂) or imino (—NH—CH₂OR) groups may also be used for reacting with α, β-unsaturated groups on the polyesters to enhance crosslinking. Suitable commercial amino resins include Maprenal BF 987 (n-butylated benzoquanamine-formaldelhyde resin available from Ineos), Cymel 1123 (highly methylated/ethylated benzoguanamine-formaldehyde resin available from Allnex), Cymel 1158 (butylated melamine-formaldehyde resin with amino functionality available from Allnex), and other benzoquanamine-formaldelhyde and melamine-formaldehyde resins.

In some embodiments, said crosslinker (b) is a combination of isocyanate crosslinker and amino crosslinker. The isocyanate crosslinker may be in an amount of 10-90, 15-85, 20-80, 25-75, 30-70, 35-65, 40-60, or 45-55 weight %, while the amino crosslinker in an amount of 90-10, 85-15, 80-20, 75-25, 70-30, 65-35, 60-40, or 55-45 weight %, based on the total weight of the crosslinkers.

In one aspect, the coating composition of the present invention comprises isocyanate crosslinker in an amount of 20-30 weight % and amino crosslinker in an amount of 70-80 weight %, based on the total weight of the crosslinkers.

Any of the coating compositions of the invention can also include one or more cross-linking catalysts. Representative crosslinking catalysts include from carboxylic acids, sulfonic acids, tertiary amines, tertiary phosphines, tin compounds, or combinations of these compounds. Some specific examples of crosslinking catalysts include p-toluenesulfonic acid, phosphoric acid, the NACURE™ 155, 5076, 1051, and XC-296B catalysts sold by King Industries, BYK 450, 470, available from BYK-Chemie U.S.A., methyl tolyl sulfonimide, p-toluenesulfonic acid, dodecylbenzene sulfonic acid, dinonylnaphthalene sulfonic acid, and dinonylnaphthalene disulfonic acid, benzoic acid, triphenylphosphine, dibutyltindilaurate, and dibutyltindiacetate.

The crosslinking catalyst used in the present invention may depend on the type of crosslinker that is used in the coating composition. For example, the crosslinker can comprise a melamine or “amino” crosslinker and the crosslinking catalyst can comprise p-toluenesulfonic acid, phosphoric acid, unblocked and blocked dodecylbenzene sulfonic (abbreviated herein as “DDBSA”), dinonylnaphthalene sulfonic acid (abbreviated herein as “DNNSA”) and dinonylnaphthalene disulfonic acid (abbreviated herein as “DNNDSA”). Some of these catalysts are available commercially such as, for example, NACURE™ 155, 5076, 1051, 5225, and XC-296B (available from King Industries), BYK-CATALYSTS™ (available from BYK-Chemie USA), and CYCAT™ catalysts (available from Cytec Surface Specialties). The coating compositions of the invention can comprise one or more isocyanate crosslinking catalysts such as, for example, FASCAT™ 4202 (dibutyltindilaurate), FASCAT™ 4200 (dibutyltindiacetate, both available from Arkema), DABCO™ T-12 (available from Air Products) and K-KAT™ 348, 4205, 5218, XC-6212™ non-tin catalysts (available from King Industries), and tertiary amines.

The coating composition can contain an acid or base catalyst in an amount ranging from 0.1 to 2 weight %, based on the total weight of any of the aforementioned curable polyester resins and the crosslinker composition.

In another embodiment, the coating composition of the present invention further comprises one or more organic solvents. Suitable organic solvents include xylene, ketones (for example, methyl amyl ketone), 2-butoxyethanol, ethyl-3-ethoxypropionate, toluene, butanol, cyclopentanone, cyclohexanone, ethyl acetate, butyl acetate, Aromatic 100 and Aromatic 150 (both available from ExxonMobil), and other volatile inert solvents typically used in industrial baking (i.e., thermosetting) enamels, mineral spirits, naptha, toluene, acetone, methyl ethyl ketone, methyl isoamyl ketone, isobutyl acetate, t-butyl acetate, n-propyl acetate, isopropyl acetate, methyl acetate, ethanol, n-propanol, isopropanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, trimethylpentanediol mono-isobutyrate, ethylene glycol mono-octyl ether, diacetone alcohol, 2,2,4-trimethyl-1,3-pentanediol monoisobutyrate (available commercially from Eastman Chemical Company under the trademark TEXANOL™), or combinations thereof.

The amount of solvents is desirably at least 20 wt. %, or at least 25 wt. %, or at least 30 wt. %, or at least 35 wt. %, or at least 40 wt. %, or at least 45 wt. %, or at least 50 wt. %, or at least 55 wt. % based on the weight of the solvent containing coating composition. Additionally, or in the alternative, the amount of organic solvents can be up to 85 wt. % based on the weight of the coating composition.

In a further embodiment, this invention provides a coating composition for use in metal packaging comprising:
a. a curable unsaturated polyester in an amount of 70-88 weight % based on the total weight of (a), (b), and (c), which is the reaction product of the monomers comprising:
   i. 2,2,4,4-tetramethyl-1,3-cyclobutanediol in an amount of 35 to 55 mole %, based on the total moles of i-iv,
   ii. 1,4-cyclohexanedimethanol in an amount of 25 to 45 mole %, based on the total moles of i-iv,
   iii. 1,6-hexanediol or 2-methyl-1,3-propanediol or a mixture thereof in an amount of 5 to 30 mole %, based on the total moles of i-iv,
   iv. trimethylolpropane in an amount of 0 to 5 mole %, based on the total moles of i-iv,
   v. an α,β-unsaturated dicarboxylic acid or anhydride in an amount of 4 to 15 mole %, based on the total moles of v-viii,
   vi. isophthalic acid in an amount of 55-85 mole %, based on the total moles of v-viii,
   vii. terephthalic acid in an amount of 5-40 mole %, based on the total moles of v-viii, and
   viii. sebacic acid or adipic acid or a mixture thereof in an amount of 0-20 mole %, based on the total moles of v-viii,
b. isophorone diisocyanate in an amount of 2-10 weight % based on the total weight of (a), (b), and (c), and
c. a benzoguanamine-formaldehyde resin in an amount of 10-20 weight % based on the total weight of (a), (b), and (c),
wherein said unsaturated polyester has a glass transition temperature (Tg) of 40 to 100° C.; an acid number of 0 to 10 mgKOH/g; a hydroxyl number of 10 to 28 mgKOH/g; a number average molecular weight of 5,000 to 14,000 g/mole; and a weight average molecular weight of 14,000 to 100,000 g/mole.

In some embodiments said coating has a solvent resistance of greater than 40 MEK double rubs as measured by ASTM D7835; and a wedge bend resistance (% pass) of 60-100 as measured by the method of ASTM D3281.

After formulation, the coating composition can be applied to a substrate or article. Thus, a further aspect of the present invention is a shaped or formed article that has been coated with the coating compositions of the present invention. The substrate can be any common substrate such as aluminum, tin, steel or galvanized sheeting, and the like. The coating composition can be coated onto a substrate using techniques known in the art, for example, by spraying, draw-down, roll-coating, etc., about 0.1 to about 4 mils (1 mil=25 μm), or 0.5 to 3, or 0.5 to 2, or 0.5 to 1 mils of wet coating onto a substrate. The coating can be cured at a temperature of about 50° C. to about 230° C., for a time period that ranges from about 5 seconds to about 90 minutes and allowed to cool. Examples of coated articles include metal cans for food and beverages, in which the interiors are coated with the coating composition of the present invention.

Thus, this invention further provides an article, of which at least a portion is coated with the coating composition of the present invention.

### EXAMPLES

This invention can be further illustrated by the following examples thereof, although it will be understood that these examples are included merely for purposes of illustration and are not intended to limit the scope of the invention unless otherwise specifically indicated.

### Coating Test Methods:

### Substrate, Coated Test Panel Preparation, Film Weight

Substrate from ThyssenKrupp Rasselstein GmbH was used: electro tin plated (ETP), thickness 0.18 mm with standard chromium passivation 311, temper TH 550, tinning 2.8/2.8 g/m² and DOS oiling 4+/−2 mg/m². The panels were coated by casting wet films with wire wound rods yielding a dry film weight of 6 to 7 grams/m². The cast panels were placed in a rack vertically. A drying oven, LUT 6050 from Thermo scientific was preheated at 205° C. The coated panels in the rack were then placed into the oven for 22 minutes of bake cycle time in order to allow the coatings to be baked at 195° C. Peak Metal Temperature (PMT) for 10 minutes. At the conclusion of the baking cycle, the panel rack was removed from the oven and allowed to cool to ambient temperature. A Sencon S19600 coating thickness gauge was used to confirm the dry film weight of the applied coatings.

### Wedge Bend

A coupon measuring 1.5″ wide×4″ long was cut from a coated panel. This coupon was tested by a Gardco coverall bend and impact tester following ASTM D 3281. To make a bend test, the coated coupon was first bent over a ⅛″ (0.32 cm) steel rod. The bent coupon was placed between the parts of a butt hinge. The hinge made of two steel blocks is attached to the base below the guide tube. When the hinge is closed, it creates a wedge shape gap between the upper and lower parts ranging from ⅛″ at the hinged end to zero thickness at the free end. Then the impact tool, flat face down, was dropped from a height of one or two feet onto the upper part of the hinge. Once a coated coupon was bent and impacted into a wedge shape, it was then soaked in an copper sulfate solution, acidified with hydrochloric acid in distilled water, for 5 minutes to make any cracks in the coating visible. Excess copper sulfate solution was removed by washing with water and blotting with a dry towel. Wedge bend failure (mm), measured by using a ruler and a lighted magnifying glass, is defined as the total length of a continuous crack along the bent edge of the coupon. The result is reported as Pass % of wedge bend which is calculated by:

$$Pass \% of wedge bend = \frac{( Total length - wedge bend failure )}{Total length} \times 100 \%$$

Each Pass % of wedge bend in this experiment is an average value from 3 repeated tests.

### Methyl Ethyl Ketone (MEK) Double Rubs

The resistance to MEK solvent was measured using a MEK rub test machine (Gardco MEK Rub Test Machine AB-410103EN with 1 kg block). This test was carried out similar to ASTM D7835. MEK solvent resistance was reported as the number of double rubs a coated panel can withstand before the coating starts to be removed. For example, one back-and-forth motion constitutes one double rub.

### Sterilization Resistance Testing

An 73 mm sanitary ends was stamped with a C-frame eccentric press, T20 Fv from MIOS out of coated panel. The sanitary ends were then placed in a 16 oz wide mouth Le Parfait glass jar filled with the food simulant Two different food simulants were evaluated:
Lactic acid: 2% lactic acid, 98% deionized water.
Acetic Acid: 3% acetic acid, 97% deionized water.
Sodium chloride: 5% NaCl 95% deionized water

The jars with properly closed top were placed in an autoclave, CYTEC Model DX 45, for 1 hr at 131° C. Once the retort process was finished, the autoclave was allowed to depressurize to ambient conditions. After the completion of sterilization cycle, the glass jars containing the test coupons were then removed from the autoclave. The sanitary ends were removed from the jars and washed under water and blotted dry with paper towels. The retort performance is rated on a scale of 0 (worst) to 5 (best) using a visual observation. For each food simulant, the retort performance was rated on (1) blush (2) roughness (3) cross-hatch adhesion (following ASTM D 3359). An overall retort performance is reported as Total Retort % calculated by:

$$Total Retort \% = \frac{\begin{matrix}average of rating ( 1 ) to ( 3 ) from 2 \% lactic acid + \\ average of rating ( 1 ) to ( 5 ) from 3 \% acetic acid + \\ average of rating from 5 \% Sodium chloride\end{matrix}}{5}$$

$$Total \% acid resistance after sterilization = \frac{\begin{matrix}average of rating ( 1 ) to ( 3 ) from 2 \% lactic acid + \\ average of rating ( 1 ) to ( 3 ) from 3 \% acetic acid \\ \end{matrix}}{5}$$

### Example 1: Synthesis of Unsaturated Polyester (Resin 1)

The unsaturated polyester (Resin 1) was produced using a resin kettle reactor setup controlled with automated control software. The resin was produced on a 3.5-4.5 mole scale using a 2 L kettle with overhead stirring and a partial condenser topped with total condenser and Dean Stark trap. Approximately 10 wt % (based on reaction yield) azeotroping solvent of high boiling point Aromatic 150ND (A150ND, available from ExxonMobile) was used to both encourage egress of the water condensate out of the reaction mixture and keep the reaction mixture viscosity at a reasonable level using the standard paddle stirrer. Isophthalic acid (IPA), terephthalic acid (TPA), 1,4-cyclohexane dimethanol (CHDM), 2,2,4,4-tetramethyl-cyclobutanediol (TMCD), 1,6-hexanediol (HDO), trimethylolpropane (TMP), and 0-10 wt % A150ND were added to the reactor, which was then completely assembled. Fascat 4100 (monobutyltin oxide, available from PMC Organometallix Inc.) was added via the sampling port after the reactor had been assembled and blanketed with nitrogen for the reaction. Additional A150/A150ND solvent was added to the Dean Stark trap to maintain the ˜10 wt % solvent level in the reaction kettle. The reaction mixture was heated without stirring from room temperature to 150° C. using a set output controlled through the automation system. Once the reaction mixture was sufficiently fluid, the stirring was started to encourage even heating of the mixture. At 150° C., the control of heating was switched to automated control and the temperature was ramped to 200° C. over the course of 3 h. The reaction was held at 200° C. for 1 h and then heated to 240° C. at a rate of 0.3 degrees/m. The reaction was then held at 240° C. and sampled every 1-2 h upon clearing until the desired acid value for Stage 1 was reached. An overnight hold temperature of 150° C. was utilized, and any additional A150ND necessary to reach the desired ˜10 wt % was added at 150° C. prior to reheating to the reaction temperature. Upon reaching the Stage 1 target acid value, the reaction mixture was cooled to 190° C., and 4-methoxyphenol (MeHQ, 1% by weight based on MA) was added and allowed to stir for 15 m. Next, in Stage 2 maleic anhydride (MA) was added to the reaction mixture and heated to 220-230° C. at 1.5° C./m. The acid value was monitored every 30-60 m until the final desired acid value was reached. The reaction mixture was then further diluted with Aromatic 100 (A100, available from ExxonMobile) to target a weight percent solids of 55-60%. This solution was filtered through a ˜250 μm paint filter prior to use in the formulation and application testing. It should be noted that the glycol excesses were determined empirically for the lab reactor and may be different depending on the partial condenser and reactor design used. The glycol:acid ratio was also manipulated to enable achieving the desired molecular weight, OHN, and AN. The raw materials are shown in Table 1.

TABLE 1
Charge

| | | | | Charge | |
|---|---|---|---|---|---|
| | | | | Weight | |
| | | | | (including | % |
| Raw Material | Moles | Equivalents | Weight | excess) | Excess |
| Stage 1 | | | | | |
| PIA | 2.8000 | 5.6000 | 465.16 | 465.16 | 0 |
| PTA | 0.5250 | 1.0500 | 87.22 | 87.22 | 0 |
| TMCD | 1.6897 | 3.3793 | 243.67 | 255.85 | 5 |
| 1,4-CHDM | 1.0672 | 2.1343 | 153.89 | 155.43 | 1 |
| HDO | 0.7470 | 1.4940 | 88.28 | 89.16 | 1 |
| TMP | 0.0534 | 0.1601 | 7.16 | 7.37 | 3 |
| Stage 2 | | | | | |
| MA | 0.1750 | 0.3500 | 17.16 | 17.16 | 0 |
| | | Total Charge | 1062.55 | | |
| | | Minus | | | |
| | | Condensate | 121.51 | | |
| | | Yield | 941.03 | | |
| (Catalyst) | Concentration | | | 0.76 | |
| Fascat 4100 | 400 | | | | |
| (Processes Solvent) | Wt. % | | | | |
| A150ND | 10 | | | 119.79 | |
| (Radical Inhibitor) | wt % on MA | | | | |
| MeHQ | 1 | | | 0.17 | |
| (Processes Solvent) | Final Wt. % | | | | |
| A100 | 60 | | | 662.89 | |

### Examples 2-8: Synthesis of Unsaturated Polyesters (Resins 2-8)

Using the same method as above, resins 2-8 were also synthesized. Table 2 lists the compositions of Resins 1-8, and Table 3 lists their resin properties.

Glass transition temperature (Tg) was determined using a Q2000 differential scanning calorimeter (DSC) from TA Instruments, New Castle, DE, US, at a scan rate of 20° C./min. Number average molecular weight (Mn) and weight average molecular weight (Mw) were measured by gel permeation chromatography (GPC) using polystyrene equivalent molecular weight and THE solvent. Acid number was measured by using a procedure based on ASTM D7253-1 entitled “Standard Test Method for Polyurethane Raw Materials: Determination of Acidity as Acid Number for Polyether Polyols,” and hydroxyl number was measured using a procedure based on ASTM E222-1 entitled “Standard Test Methods for Hydroxyl Groups Using Acetic Anhydride. Table 3 lists the resin properties of Resins 1-8.

TABLE 2
Synthesized Unsaturated Polyesters

| | Mole Ratio Based on Total Acids (%) | | | | | | | | |
|---|---|---|---|---|---|---|---|---|---|
| | SE | AD | MA | IPA | TPA | TMP | TMCD | CHDM | HDO |
| Resin #, | mol % | mol % | mol % | mol % | mol % | mol % | mol % | mol % | mol % |
| 1 | 0 | 0 | 5 | 80 | 15 | 1.5 | 47.5 | 30 | 21 |
| 2 | 0 | 0 | 5 | 80 | 15 | 1.5 | 47.5 | 30 | 21 |
| 3 | 0 | 0 | 5 | 80 | 15 | 1.5 | 40.5 | 29 | 29 |
| 4 | 0 | 0 | 5 | 80 | 15 | 1.5 | 44 | 28.5 | 26 |
| 5 | 0 | 0 | 15 | 55 | 15 | 3 | 45 | 35 | 20 |
| 6 | 7.5 | 0 | 7.5 | 62.5 | 22.5 | 1.5 | 43.5 | 35 | 20 |
| 7 | 0 | 0 | 5 | 80 | 15 | 1.5 | 40.5 | 29 | 29 |
| 8 | 0 | 0 | 5 | 80 | 15 | 1.5 | 40.5 | 29 | 29 |

TABLE 3
Resin Properties of Unsaturated Polyesters

| Resin # | Tg, C. | Mn | Mw | AN | OHN |
|---|---|---|---|---|---|
| 1 | 77 | 9072 | 32967 | 4.8 | 14.6 |
| 2 | 72 | 7346 | 18529 | 6.0 | 25.1 |
| 3 | 65 | 12537 | 40209 | 5.3 | 11.6 |
| 4 | 71 | 10594 | 31187 | 4.7 | 14.5 |
| 5 | 71 | 5891 | 50964 | 2.8 | 22.3 |
| 6 | 55 | 5919 | 20147 | 4.3 | 21.3 |
| 7 | 68 | 5992 | 20489 | 4.8 | 19.0 |
| 8 | 60 | 7799 | 19362 | 5.9 | 24.6 |

### Comparative Examples 1: Synthesis of Comparative Unsaturated Polyester CR11

Using the same method as above, comparative resin (CR1) was also synthesized. Table 4 lists the composition of resin CR1. Table 5 lists its resin properties. CR1 has low maleic anhydride (2.3 mole %) as compared to the inventive polyester.

TABLE 4
Synthesized Comparative Unsaturated Polyesters

| | Mole Ratio Based on Total Acids (%) | | | | Mole Ratio Based on Total Alcohols (%) | | | |
|---|---|---|---|---|---|---|---|---|
| | SE | MA | IPA | TPA | TMP | TMCD | CHDM | HDO |
| Resin # | mol % | mol % | mol % | mol % | mol % | mol % | mol % | mol % |
| CR1 | 14.8 | 2.3 | 61.5 | 21.5 | 1 | 44 | 35 | 20 |

TABLE 5
Resin Properties of Comparative Unsaturated Polyesters

| Run | Tg, C. | Mn | Mw | AN | OHN |
|---|---|---|---|---|---|
| CR1 | 49 | 5322 | 15402 | 3.2 | 26.6 |

### Comparative Examples 2-5: Synthesis of Polyesters without Ethylenically Unsaturated Groups (CR2-5)

The polyesters were produced using a resin kettle reactor setup controlled with automated control software. The compositions were produced on a 3.5-4.5 mole scale using a 2 L kettle with overhead stirring and a partial condenser topped with total condenser and Dean Stark trap. Approximately 10 wt % (based on reaction yield) azeotroping solvent of high boiling point Aromatic 150ND (A150ND, available from ExxonMobile) was used to both encourage egress of the water condensate out of the reaction mixture and keep the reaction mixture viscosity at a reasonable level using the standard paddle stirrer. Isophthalic acid (IPA), terephthalic acid (TPA), sebacic acid (SE), succinic acid (SU), 1,4-cyclohexane dimethanol (CHDM), 2,2,4,4-tetramethyl-cyclobutanediol (TMCD), 1,6-hexanediol (HDO), trimethylolpropane (TMP), and 0-10 wt % A150ND were added to the reactor, which was then completely assembled. Fascat 4100 (monobutyltin oxide, available from PMC Organometallix Inc.) was added via the sampling port after the reactor had been assembled and blanketed with nitrogen for the reaction. Additional A150/A150ND solvent was added to the Dean Stark trap to maintain the ˜10 wt % solvent level in the reaction kettle. The reaction mixture was heated without stirring from room temperature to 150° C. using a set output controlled through the automation system. Once the reaction mixture was sufficiently fluid, the stirring was started to encourage even heating of the mixture. At 150° C., the control of heating was switched to automated control and the temperature was ramped to 200° C. over the course of 3 h. The reaction was held at 200° C. for 1 h and then heated to 240° C. at a rate of 0.3 degrees/m. The reaction was then held at 240° C. and sampled approximately every 60 m upon clearing until the desired acid value was reached. An overnight hold temperature of 150° C. was utilized, and any additional A150ND was added at 150° C. prior to reheating to the reaction temperature. The reaction mixture was then further diluted with Aromatic 100 (A100, available from ExxonMobile) to target a weight percent solid of 55-60%. This solution was filtered through a ˜250 μm paint filter prior to use in the formulation and application testing. As with previous examples, the glycol excesses were determined empirically for the lab reactor and may be different depending on the partial condenser and reactor design used. An example of a basic charge sheet is provided below. The glycol:acid ratio was also manipulated to enable achieving the desired molecular weight, OHN, and AN. The same analytical methods were used as described above. The raw materials are shown in Table 6.

TABLE 6
Charge

| | | | | Charge | |
|---|---|---|---|---|---|
| | | | | Weight | |
| | | | | (including | % |
| Raw Material | Moles | Equivalents | Weight | excess) | Excess |
| Stage 1 | | | | | |
| PIA | 2.2500 | 4.5000 | 373.79 | 373.79 | 0 |
| PTA | 0.8100 | 1.6200 | 134.57 | 134.57 | 0 |
| Sebacic Acid | 0.2700 | 0.5400 | 54.62 | 54.62 | 0 |
| Succinic Acid | 0.2700 | 0.5400 | 31.89 | 31.89 | 0 |
| TMCD | 1.6071 | 3.2142 | 231.76 | 243.35 | 5 |
| 1,4-CHDM | 1.2931 | 2.5862 | 186.48 | 188.34 | 1 |
| HDO | 0.7389 | 1.4778 | 87.32 | 88.20 | 0 |
| TMP | 0.0554 | 0.1663 | 7.44 | 7.51 | 1 |
| MA | 0.6750 | 1.3500 | 66.19 | 66.19 | 0 |
| | | Total Charge | 1100.43 | | |
| | | Minus | | | |
| | | Condensate | 128.33 | | |
| | | Yield | 972.10 | | |
| (Catalyst) | Concentration | | | | |
| Fascat 4100 | 400 | | | 0.79 | |
| (Processes Solvent) | Wt. % | | | | |
| A150ND | 10 | | | 124.78 | |
| (Processes Solvent) | Final Wt. % | | | | |
| A100 | 60 | | | 538.37 | |

Table 7 lists the compositions of resins CR2-5. Table 8 lists their resin properties. These examples represent negative controls without the presence of maleic anhydride. CR2 represent resins in which the maleic anhydride was replaced with succinic acid, which has the same number of carbon groups but is saturated.

TABLE 7
Synthesized Comparative Polyesters without Unsaturated Groups

| | Mole Ratio Based on Total Acids (%) | | | | Mole Ratio Based on Total Alcohols (%) | | | |
|---|---|---|---|---|---|---|---|---|
| | SE | SU | IPA | TPA | TMP | TMCD | CHDM | HDO |
| Resin # (Run) | mol % | mol % | mol % | mol % | mol % | mol % | mol % | mol % |
| CR2 | 7.5 | 7.5 | 62.5 | 22.5 | 1.5 | 43.5 | 35 | 20 |
| CR3 | 8.5 | 0 | 65.7 | 25.7 | 0.7 | 44.3 | 35 | 20 |
| CR4 | 0 | 0 | 70 | 30 | 0 | 45 | 35 | 20 |
| CR5 | 7.6 | 0 | 66.2 | 26.2 | 3 | 42 | 35 | 20 |

TABLE 8
Resin Properties of Comparative Polyesters without
Unsaturated Group

| Resin # (Run) | Tg, C. | Mn | Mw | AN | OHN |
|---|---|---|---|---|---|
| CR2 | 52 | 6962 | 22276 | 4.0 | 17.8 |
| CR3 | 50 | 7229 | 23001 | 3.8 | 23.1 |
| CR4 | 75 | 4574 | 12539 | 0.5 | 25.7 |
| CR5 | 59 | 5581 | 23907 | 3.1 | 24.5 |

### Example 9: Preparation of Coating Formulations Using Isocyanate and Amino Resin as Crosslinkers (F1-8 and CF1-5)

Coating formulations were prepared in accordance with the composition listed in Table 9 by using Resins 1-8 and Comparative Resins CR1-5 respectively. Coating formulations (F1-8) prepared from Resins 1-8 are listed in Table 10, and the comparative formulations (CF1-5) prepared from CR 1-5 are listed in Table 11.

Prior to formulating, all polyester resins were diluted in aromatic 100 to 55 wt. % solids. A pigment paste was made with polyester solution and Titanium dioxide (TiO2) Ti-Pure™ R900 at a 1 to 1 ratio. An empty jar with a lid was labeled and pre-weighted to record the tare weight. For each formulation, The pigment paste, Maprenal®BF 987, Desmodur® BL 2078/2, Nacure® 5925, Fascat® 9102 Lubaprint 897 PM (ND), Byk 392 and aromatic 100 solvent were weighed out respectively and added to the resin solution in order. The formulation was then sheared for 2 min at 3000 RPMs with a SpeedMixer DAC 150.1 FVZ-K

A food grade approved Desmodur® BL 2078/2 available from Covestro AG, and Maprenal®BF 987 available from Prefere resins were chosen as blocked IPDI trimer and methylated benzoguananamine-formaldehyde resin resin crosslinkers, respectively. A food grade approved Nacure® 5925 available from King Industries and Fascat® 9102 available from PMC organometallix was respectively chosen as dodecylbenzene sulfonic acid and organo tin catalysts. A carnauba wax, Lubaprint 897 PM (ND) available from Munzing was used and a surface additive, Byk 392, available from BYK was chosen.

TABLE 9
Coating Formulations (F1-8 and CF1-5)

| | Solids/Active | Weight |
|---|---|---|
| Component | % | (g) |
| Polyester resin (55% solution in | 55% | 12.47 |
| Aromatic 100) | | |
| Pigment paste polyester solution | 77.5% | 55.01 |
| (55%) Ti-Pure ™ R900 1: 1 | | |
| Desmodur ® BL 2078/2 | 50% | 2.29 |
| Maprenal ® BF 987 | 74% | 5.59 |
| Nacure ® 5925 | 25% | 0.30 |
| Fascat ® 9102 10% solution in | 10% | 0.41 |
| Aromatic 100 | | |
| Lubaprint 897 PM (ND) | 10% | 1.83 |
| Byk 392 | 52% | 0.20 |
| Aromatic 100 | 0% | 21.89 |

| | |
|---|---|
| Total | 100.00 |
| % Total solids | 55.0% |
| % Polyester resin on total binder | 80.00% |
| % IPDI on total binder | 5.00% |
| % Benzoguanamine on total binder | 15.00% |

### Example 10: Coating Properties of Formulations with Isocyanate and Amino Resin (F1-8)

The formulations prepared were applied on substrate from ThyssenKrupp Rasselstein GmbH, electro tin plated (ETP), thickness 0.18 mm with standard chromium passivation 311, temper TH 550, tinning 2.8/2.8 g/m² and DOS oiling 4+/−2 mg/m² by casting wet films with wire wound rods yielding to dry film weight to achieve approximately 14-16 grams/m2. The cast panels were placed in a rack and held vertically in an oven for cure

A drying oven, LUT 6050 from Thermo scientific was preheated at 205° C. The coated panels in the rack were then placed into the oven for 22 minutes of bake cycle time in order to allow the coatings to be baked at 195° C. Peak Metal Temperature (PMT) for 10 minutes. At the conclusion of the baking cycle, the panel rack was removed from the oven and allowed to cool to ambient temperature. A Sencon S19600 coating thickness gauge was used to confirm the dry film weight of the applied coatings.

The coatings thus prepared were then tested for their properties according to the methods described previously. Table 10 lists the coating properties of Formulations F1-8. Table 11 lists the coating properties of Comparative Formulations CF1-5.

TABLE 10
Coating Properties of Unsaturated Polyesters

| | | | Pass | | |
|---|---|---|---|---|---|
| | | MEK | % of | | |
| | | Double | Wedge | % total | % acid |
| Formulation | Resin # | rubs | bend | retort | resistance |
| F1 | 1 | 41 | 88 | 73 | 70 |
| F2 | 2 | 61 | 88 | 71 | 63 |
| F3 | 3 | 67 | 91 | 80 | 70 |
| F4 | 4 | 42 | 87 | 76 | 77 |
| F5 | 5 | 29 | 82 | 60 | 37 |
| F6 | 6 | 26 | 80 | 73 | 57 |
| F7 | 7 | 20 | 89 | 76 | 70 |
| F8 | 8 | 25 | 91 | 75 | 70 |

### Comparative Example 6: Coating Properties of Comparative Formulations (CF1-5)

TABLE 11
Comparative Coating Properties

| | | | Pass | | |
|---|---|---|---|---|---|
| | | MEK | % of | | |
| | Resin # | Double | Wedge | % total | % acid |
| Formulation | (Run) | rubs | bend | retort | resistance |
| CF1 | CR1 | 5 | 28 | 71 | 60 |
| CF2 | CR2 | 9 | 86 | 82 | 73 |
| CF3 | CR3 | 5 | 38 | 67 | 60 |
| CF4 | CR4 | 1 | 32 | 35 | 27 |
| CF5 | CR5 | 8 | 31 | 73 | 67 |

### Example 11: Synthesis of Unsaturated Polyesters (Resins 9-10)

Using the same method as above, resins 9-10 were synthesized. Table 12 lists the compositions of Resins 9-10, and Table 13 lists their resin properties.

TABLE 12
Synthesized Unsaturated Polyesters

| | Mole Ratio Based on Total Acids (%) | | | | | Mole Ratio Based on Total Alcohols (%) | | | | |
|---|---|---|---|---|---|---|---|---|---|---|
| | SE | AD | MA | IPA | TPA | TMP | TMCD | CHDM | MPdiol | HDO |
| Resin # | mol % | mol % | mol % | mol % | mol % | mol % | mol % | mol % | mol % | mol % |
| 9 | 7.5 | 0 | 7.5 | 62.5 | 22.5 | 1.5 | 43.5 | 35 | 0 | 20 |
| 10 | 0 | 0 | 15 | 62.5 | 22.5 | 0 | 45 | 35 | 0 | 20 |

TABLE 13
Resin Properties of Unsaturated Polyesters

| Resin # (Run) | Tg, C. | Mn | Mw | AN | OHN |
|---|---|---|---|---|---|
| 9 | 61.9 | 6973 | 29475 | 1.0 | 21.2 |
| 10 | 67.5 | 5361 | 16865 | 6.3 | 14.3 |

### Example 12: Preparation of Coating Formulations Using Unsaturated Polyesters and Isocyanate or Various Amino Crosslinkers (F9-16)

Coating formulations F9-16 were prepared in accordance with the composition listed in Table 14 by using Resins 9-10 and either isocyanate crosslinker or amino crosslinker exclusively.

Prior to formulating, all polyester resins were diluted in aromatic 100 to 55 wt. % solids. A pigment paste was made with polyester solution and Titanium dioxide (TiO2) Ti-Pure™ R900 at a 1 to 1 ratio. An empty jar with a lid was labeled and pre-weighted to record the tare weight. For each formulation, The pigment paste, Desmodur® BL 2078/2 or Maprenal®BF 987, or Cymel 327 or Cymel 1123, Nacure® 5925, Fascat® 9102 Lubaprint 897 PM (ND), Byk 392 and aromatic 100 solvent were weighed out respectively and added to the resin solution in order. The formulation was then sheared for 2 min at 3000 RPMs with a SpeedMixer DAC 150.1 FVZ-K

A food grade approved Desmodur® BL 2078/2 available from Covestro AG, Maprenal®BF 987 available from Prefere resins, Cymel® 327 from Allnex, Cymel® 1123 from Allnex were chosen as blocked IPDI trimer, methylated benzoguananamine-formaldehyde resin, methylated melamine, methylated/ethylated benzoguanamine crosslinkers, respectively. A food grade approved Nacure® 5925 available from King Industries and Fascat® 9102 available from PMC organometallix was respectively chosen as dodecylbenzene sulfonic acid and organo tin catalysts. A carnauba wax, Lubaprint 897 PM (ND) available from Munzing was used and a surface additive, Byk 392, available from BYK was chosen.

TABLE 14
Coating Formulations (F9-16)

| | | Weight | Weight | Weight | Weight |
|---|---|---|---|---|---|
| | | (g) | (g) | (g) | (g) |
| | Solids/Active | F9 and | F10 and | F11 and | F12 and |
| Component | % | F13 | F14 | F15 | F16 |
| Polyester resin (55% solution in Aromatic 100) | 55% | 12.47 | 12.47 | 12.47 | 12.47 |
| Pigment paste polyester solution | 77.5% | 55.01 | 55.01 | 55.01 | 55.01 |
| (55%): Ti-Pure ™ R900 1: 1 | | | | | |
| Desmodur ® BL 2078/2 | 50% | 6.45 | | | |
| Maprenal ® BF 987 | 74% | | 5.20 | | |
| Cymel ® 327 | 90% | | | 4.30 | |
| Cymel ® 1123 | 98% | | | | 3.87 |
| Nacure ® 5925 | 25% | | 0.30 | 0.30 | 0.30 |
| Fascat ® 9102 10% solution in Aromatic 100 | 10% | 0.41 | | | |
| Lubaprint 897 PM (ND) | 10% | 1.83 | 1.83 | 1.83 | 1.83 |
| Byk 392 | 52% | 0.20 | 0.20 | 0.20 | 0.20 |
| Aromatic 100 | 0% | 20.60 | 22.00 | 22.90 | 23.40 |

| | | | | |
|---|---|---|---|---|
| Total | 96.98 | 97.01 | 97.01 | 97.08 |
| % Total solids | 55.0% | 55.0% | 55.0% | 55.0% |
| % Polyester resin on total binder | 85.00% | 85.00% | 85.00% | 85.00% |
| % crosslinker on total binder | 15.00% | 15.00% | 15.00% | 15.00% |

### Example 13: Coating Properties of Formulations F9-16

The formulations prepared were applied on substrate from ThyssenKrupp Rasselstein GmbH, electro tin plated (ETP), thickness 0.18 mm with standard chromium passivation 311, temper TH 550, tinning 2.8/2.8 g/m² and DOS oiling 4+/−2 mg/m² by casting wet films with wire wound rods yielding to dry film weight to achieve approximately 14-16 grams/m2. The cast panels were placed in a rack and held vertically in an oven for cure

A drying oven, LUT 6050 from Thermo scientific was preheated at 205° C. The coated panels in the rack were then placed into the oven for 22 minutes of bake cycle time in order to allow the coatings to be baked at 195° C. Peak Metal Temperature (PMT) for 10 minutes. At the conclusion of the baking cycle, the panel rack was removed from the oven and allowed to cool to ambient temperature. A Sencon S19600 coating thickness gauge was used to confirm the dry film weight of the applied coatings.

The coatings thus prepared were then tested for their properties according to the methods described previously. Table 15 lists the coating properties of Formulations F9-16. This example demonstrated that coatings with only isocyanate crosslinker exhibited higher MEK double rubs than those with only amino resins without free amino (—NH₂) or imino (—NH—CH₂OR) groups. In contrast, formulations with amino resins having imino groups yielded coatings with extra high MEK double rubs.

TABLE 15
Coating Properties

| | | | Pass | | |
|---|---|---|---|---|---|
| | | MEK | % of | | |
| | Resin # | Double | Wedge | % total | % acid |
| Formulation | (Run) | rubs | bend | retort | resistance |
| F9 | 9 | 66 | 57 | 61 | 42 |
| F10 | 9 | 1 | 45 | 71 | 47 |
| F11 | 9 | >200 | 58 | 71 | 57 |
| F12 | 9 | 1 | 37 | 72 | 58 |
| F13 | 10 | 24 | 55 | 72 | 58 |
| F14 | 10 | 12 | 43 | 84 | 77 |
| F15 | 10 | 76 | 34 | 67 | 50 |
| F16 | 10 | 25 | 46 | 76 | 63 |

### Comparative Example 7: Synthesis of Comparative Polyesters without Unsaturated Groups (CR6-7)

Using the same method as above, comparative resins CR6-7 were synthesized. Table 16 lists the compositions of Resins 6-7, and Table 17 lists their resin properties.

TABLE 16
Synthesized Comparative Polyesters without Unsaturated Groups

| | Mole Ratio Based on Total Acids (%) | | | | | Mole Ratio Based on Total Alcohols (%) | | | | |
|---|---|---|---|---|---|---|---|---|---|---|
| | SE | SU | MA | IPA | TPA | TMP | TMCD | CHDM | MPdiol | HDO |
| Resin # | mol % | mol % | mol % | mol % | mol % | mol % | mol % | mol % | mol % | mol % |
| CR6 | 7.5 | 7.5 | 0 | 62.5 | 22.5 | 1.5 | 43.5 | 35 | 0 | 20 |
| CR7 | 15 | 15 | 0 | 55 | 15 | 0 | 45 | 35 | 0 | 20 |

TABLE 17
Resin Properties of Comparative Polyesters
without Unsaturated Groups

| Resin # | Tg, C. | Mn | Mw | AN | OHN |
|---|---|---|---|---|---|
| CR6 | 51.7 | 6962 | 22276 | 3.6 | 17.8 |
| CR7 | 38.9 | 7456 | 20012 | 3.6 | 13.2 |

### Comparative Example 8: Preparation of Coating Formulations Using Saturated Polyesters and Isocyanate or Various Amino Crosslinkers (CF6-13)

Coating formulations were prepared in accordance with the composition listed in Table 18 by using comparative resins CR7-8 and either isocyanate crosslinker or amino crosslinker exclusively.

Prior to formulating, all polyester resins were diluted in aromatic 100 to 55 wt. % solids. A pigment paste was made with polyester solution and Titanium dioxide (TiO2) Ti-Pure™ R900 at a 1 to 1 ratio An empty jar with a lid was labeled and pre-weighted to record the tare weight. For each formulation, The pigment paste, Desmodur® BL 2078/2 or Maprenal®BF 987, or Cymel 327 or Cymel 1123, Nacure® 5925, Fascat® 9102 Lubaprint 897 PM (ND), Byk 392 and aromatic 100 solvent were weighed out respectively and added to the resin solution in order. The formulation was then sheared for 2 min at 3000 RPMs with a SpeedMixer DAC 150.1 FVZ-K

A food grade approved Desmodur® BL 2078/2 available from Covestro AG, Maprenal®BF 987 available from Prefere resins, Cymel® 327 from Allnex, Cymel® 1123 from Allnex were chosen as blocked IPDI trimer, methylated benzoguananamine-formaldehyde resin, methylated melamine, methylated/ethylated benzoguanamine crosslinkers, respectively. A food grade approved Nacure® 5925 available from King Industries and Fascat® 9102 available from PMC organometallix was respectively chosen as dodecylbenzene sulfonic acid and organo tin catalysts. A carnauba wax, Lubaprint 897 PM (ND) available from Munzing was used and a surface additive, Byk 392, available from BYK was chosen.

TABLE 18
Coating Formulations (CF6-13)

| | | Weight | Weight | Weight | Weight |
|---|---|---|---|---|---|
| | | (g) | (g) | (g) | (g) |
| | Solids/Active | CF6 and | CF7 and | CF8 and | CF9 and |
| Component | % | CF10 | CF11 | CF12 | CF 13 |
| Polyester resin (55% solution in Aromatic 100) | 55% | 12.47 | 12.47 | 12.47 | 12.47 |
| Pigment paste polyester solution (55%): | 77.5% | 55.01 | 55.01 | 55.01 | 55.01 |
| Ti-Pure ™ R900 1: 1 | | | | | |
| Desmodur ® BL 2078/2 | 50% | 6.45 | | | |
| Maprenal ® BF 987 | 74% | | 5.20 | | |
| Cymel ® 327 | 90% | | | 4.30 | |
| Cymel ® 1123 | 98% | | | | 3.87 |
| Nacure ® 5925 | 25% | | 0.30 | 0.30 | 0.30 |
| Fascat ® 9102 10% solution in Aromatic 100 | 10% | 0.41 | | | |
| Lubaprint 897 PM (ND) | 10% | 1.83 | 1.83 | 1.83 | 1.83 |
| Byk 392 | 52% | 0.20 | 0.20 | 0.20 | 0.20 |
| Aromatic 100 | 0% | 20.60 | 22.00 | 22.90 | 23.40 |

| | | | | |
|---|---|---|---|---|
| Total | 96.98 | 97.01 | 97.01 | 97.08 |
| % Total solids | 55.0% | 55.0% | 55.0% | 55.0% |
| % Polyester resin on total binder | 85.00% | 85.00% | 85.00% | 85.00% |
| % crosslinker on total binder | 15.00% | 15.00% | 15.00% | 15.00% |

### Comparative Example 9: Coating Properties of Formulations CF6-13

The formulations prepared were applied on substrate from ThyssenKrupp Rasselstein GmbH, electro tin plated (ETP), thickness 0.18 mm with standard chromium passivation 311, temper TH 550, tinning 2.8/2.8 g/m² and DOS oiling 4+/−2 mg/m². by casting wet films with wire wound rods yielding to dry film weight to achieve approximately 6-8 grams/m2. The cast panels were placed in a rack and held vertically in an oven for cure

A drying oven, LUT 6050 from Thermo scientific was preheated at 205° C. The coated panels in the rack were then placed into the oven for 22 minutes of bake cycle time in order to allow the coatings to be baked at 195° C. Peak Metal Temperature (PMT) for 10 minutes. At the conclusion of the baking cycle, the panel rack was removed from the oven and allowed to cool to ambient temperature. A Sencon S19600 coating thickness gauge was used to confirm the dry film weight of the applied coatings.

The coatings thus prepared were then tested for their properties according to the methods described previously. Table 19 lists the coating properties of Formulations CF6-13. This example demonstrated that, in the absence of α,β-unsaturated groups, coatings with isocyanate crosslinker showed lower MEK double rubs.

TABLE 19
Comparative Coating Properties

| | | | Pass | | |
|---|---|---|---|---|---|
| | | MEK | % of | | |
| | | Double | Wedge | % total | % acid |
| Formulation | Resin # | rubs | bend | retort | resistance |
| CF6 | CR6 | 32 | 54 | 62 | 43 |
| CF7 | CR6 | 4 | 41 | 73 | 60 |
| CF8 | CR6 | 190 | 49 | 63 | 45 |
| CF9 | CR6 | 1 | 42 | 73 | 60 |
| CF10 | CR7 | 18 | 60 | 69 | 53 |
| CF11 | CR7 | 1 | 52 | 70 | 55 |
| CF12 | CR7 | 59 | 58 | 62 | 43 |
| CF13 | CR7 | 1 | 40 | 72 | 58 |

### Examples 14-16: Synthesis of Unsaturated Polyesters Using Tin-Free Catalyst (Resins TF1-3)

Using the same method as above, resins TF1-3 were also synthesized with the catalyst Fascat 4100 (monobutyltin oxide) replaced by titanium isopropoxide (concentration: 90 ppm). Table 20 lists the compositions of Resins TF1-3, and Table 21 lists their resin properties.

TABLE 20
Synthesized Polyesters using Tin-free Catalyst

| | Mole Ratio Based on Total Acids (%) | | | | | Mole Ratio Based on Total Alcohols (%) | | | |
|---|---|---|---|---|---|---|---|---|---|
| | SE | AD | MA | IPA | TPA | TMP | TMCD | CHDM | HDO |
| Resin # | mol % | mol % | mol % | mol % | mol % | mol % | mol % | mol % | mol % |
| TF1 | 7.5 | 0 | 7.5 | 62.5 | 22.5 | 1.5 | 43.5 | 35 | 20 |
| TF2 | 0 | 7.5 | 7.5 | 62.5 | 22.5 | 1.5 | 43.5 | 35 | 20 |
| TF3 | 0 | 0 | 7.5 | 66.25 | 26.25 | 1.5 | 40 | 28.5 | 30 |

TABLE 21
Resin Properties of Polyesters using Tin-free Catalyst

| Resin # | Tg, C. | Mn | Mw | AN | OHN |
|---|---|---|---|---|---|
| TF1 | 54 | 6475 | 21671 | 4.8 | 15.6 |
| TF2 | 62 | 6609 | 23169 | 4.6 | 19.3 |
| TF3 | 57 | 4626 | 13256 | 3.7 | 28.5 |

The invention has been described in detail with reference to the embodiments disclosed herein, but it will be understood that variations and modifications can be effected within the spirit and scope of the invention.

What is claimed is:

1. A thermosetting coating composition comprising:
a. a curable unsaturated polyester, which is the reaction product of the monomers comprising:
i. a cycloaliphatic diol in an amount of 57 to 100 mole %, based on the total moles of i-iii,
ii. an acyclic diol in an amount of 0 to 35 mole %, based on the total moles of i-iii,
iii. a polyol having 3 or more hydroxyl groups in an amount of 0 to 8 mole %, based on the total moles of i-iii,
iv. an α,β-unsaturated dicarboxylic acid or anhydride in an amount of 3 to 20 mole %, based on the total moles of iv-vi,
v. an aromatic diacid in an amount of 55 to 97 mole %, based on the total moles of iv-vi, and
vi. a saturated aliphatic diacid in an amount of 0 to 25 mole %, and
b. one or more crosslinkers selected from isocyanate crosslinker and amino crosslinker,
wherein said unsaturated polyester has a hydroxyl number of 8 to 30 mgKOH/g, an acid number of 0 to 10 mgKOH/g, a glass transition temperature (Tg) of 35 to 110° C., number average molecular weight of 4,000 to 25,000 g/mole, and weight average molecular weight of 13,000 to 200,000 g/mole.

2. The coating composition of any of the preceding claims, wherein the coating has a solvent resistance of greater than 40 MEK double rubs as measured by ASTM D7835.

3. The coating composition of any of the preceding claims, wherein the coating has a wedge bend resistance (% pass) of 60-100 as measured by ASTM D3281.

4. The coating composition of any of the preceding claims, wherein said cycloaliphatic diol (i) is in an amount of 72 to 89 mole %, said acyclic diol (ii) in an amount of 10 to 25 mole %, said polyol (iii) in an amount of 1 to 3 mole %, said α,β-unsaturated diacid or anhydride (iv) in an amount of 4 to 8 mole %, said aromatic diacid (v) in an amount of 74 to 96 mole %, and said aliphatic diacid (vi) in an amount of 0 to 18 mole %.

5. The coating composition of any of the preceding claims, wherein said cycloaliphatic diol (i) is one or more selected from the group consisting of 2,2,4,4-tetramethyl-1,3-cyclobutanediol, 1,4-cyclohexanedimethanol, 1,3-cyclohexanedimethanol, tricyclodecanedimethanol, isosorbide, and dinorbornanedimethanol.

6. The coating composition of any of the preceding claims, wherein said acyclic diol (ii) is one or more selected from the group comprising 1,6-hexanediol, 1,4-butanediol, 2-methyl-1,3-propanediol, and neopentyl glycol.

7. The coating composition of any of the preceding claims, wherein said α,β-unsaturated diacid or anhydride (iv) is one or more selected from the group comprising maleic anhydride, maleic acid, fumaric acid, itaconic anhydride, and itaconic acid,

8. The coating composition of any of the preceding claims, wherein said aliphatic diacid is one or more selected from the group comprising succinic acid, adipic acid, sebacic acid, 1,4-cyclohexane dicarboxylic acid, and 1,3-cyclohexane dicarboxylic acid.

9. The coating composition of any of the preceding claims, wherein said unsaturated polyol (a) has a hydroxyl number of 11-26 mgKOH/g.

10. The coating composition of any of the preceding claims, wherein said unsaturated polyol (a) has a Tg of 60-80° C.

11. The coating composition of any of the preceding claims, wherein the crosslinker is an isocyanate crosslinker.

12. The coating composition of any of the preceding claims, wherein the crosslinker is an amino crosslinker.

13. The coating composition of any of the preceding claims, wherein the crosslinker is a combination of isocyanate crosslinker and amino crosslinker.

14. The coating composition of any of the preceding claims, wherein said isocyanate crosslinker is in an amount of 20-30 weight % and said amino crosslinker in an amount of 70-80 weight %, based on the total weight of the crosslinkers.

15. The coating composition of any of the preceding claims, wherein said isocyanate is isophorone diisocyanate.

16. The coating composition of any of the preceding claims, wherein said amino crosslinker is a benzoguanamine-formaldehyde type.

17. The coating composition of any of the preceding claims, further comprising one or more organic solvents selected from the group comprising xylene, methyl amyl ketone, 2-butoxyethanol, ethyl-3-ethoxypropionate, toluene, butanol, cyclopentanone, cyclohexanone, ethyl acetate, butyl acetate, Aromatic 100, and Aromatic 150 available from ExxonMobil.

18. A thermosetting coating composition for use in metal packaging comprising:
a. a curable unsaturated polyester in an amount of 70-88 weight % based on the total weight of (a), (b), and (c), which is the reaction product of the monomers comprising:
i. 2,2,4,4-tetramethyl-1,3-cyclobutanediol in an amount of 35 to 55 mole %, based on the total moles of i-iv,
ii. 1,4-cyclohexanedimethanol in an amount of 25 to 45 mole %, based on the total moles of i-iv,
iii. 1,6-hexanediol or 2-methyl-1,3-propanediol or a mixture thereof in an amount of 5 to 30 mole %, based on the total moles of i-iv,
iv. trimethylolpropane in an amount of 0 to 5 mole %, based on the total moles of i-iv,
v. an α,β-unsaturated dicarboxylic acid or anhydride in an amount of 4 to 15 mole %, based on the total moles of v-viii,
vi. isophthalic acid in an amount of 55-85 mole %, based on the total moles of v-viii,
vii. terephthalic acid in an amount of 5-40 mole %, based on the total moles of v-viii, and
viii. sebacic acid or adipic acid or a mixture thereof in an amount of 0-20 mole %, based on the total moles of v-viii,
b. isophorone diisocyanate in an amount of 2-10 weight % based on the total weight of (a), (b), and (c), and
c. a benzoquanamine-formaldehyde resin in an amount of 10-20 weight % based on the total weight of (a), (b), and (c),
wherein said unsaturated polyol has a glass transition temperature (Tg) of 40 to 100° C.; an acid number of 0 to 10 mgKOH/g; a hydroxyl number of 10 to 28 mgKOH/g; a number average molecular weight of 5,000 to 14,000 g/mole; and a weight average molecular weight of 14,000 to 100,000 g/mole.

19. The coating composition of claim 24, wherein said coating has a solvent resistance of greater than 40 MEK double rubs as measured by ASTM D7835; and a wedge bend resistance (% pass) of 60-100 as measured by the method of ASTM D3281.

20. An article, of which at least a portion is coated with the coating composition of any of the preceding claims.
